(19) United States
(12) Patent Application Publication
(10) Pub. No.: US 2017/0002682 A1
(43) Pub. Date: Jan. 5, 2017

(54) DETECTION METHOD OF SENSOR IN GAS TURBINE

(71) Applicant: SIEMENS AKTIENGESELLSCHAFT, Muenchen (DE)

(72) Inventors: Ow LAU, Shanghai (CN); Thomas NEUENHAHN, Dusseldorf (DE); Chao REN, Shanghai (CN); Jie ZHENG, Beijing (CN)

(73) Assignee: Siemens Aktiengesellschaft, Muenchen (DE)

(21) Appl. No.: 15/039,928

(22) PCT Filed: Nov. 29, 2013
(86) PCT No.: PCT/CN2013/088240

§ 371 Date: May 27, 2016

(51) Int. Cl. F01D 21/00; F01D 17/14; F01D 9/04

(52) U.S. Cl. CPC F01D 21/003; F01D 9/041; F01D 17/14; F05D 2220/32; F05D 2260/50

(57) ABSTRACT

A detection method of a sensor in a gas turbine includes adopting a pressure sensor to measure a pushing force of a push rod; measuring a first rotational angle of a guide vane where a first angle sensor is mounted; measuring a second rotational angle of the guide vane where a second angle sensor is mounted; obtaining a maximum measured rotational angle deviation from the absolute value of a difference value between the first and second rotational angles; calculating a maximum calculated deviation from the pushing force of the push rod; calculating the absolute value of a difference value between the maximum measured deviation and the maximum calculated deviation; and determining that the angle sensors and the pressure sensor have appropriate measurement accuracy; or, if the absolute value is greater than the standard value, determining that the angle and/or pressure sensors require calibration.

### PRIORITY STATEMENT

This application is the national phase under 35 U.S.C. §371 of PCT International Application No. PCT/CN2013/088240 which has an International filing date of Nov. 29, 2013, which designated the United States of America, the entire contents of which are hereby incorporated herein by reference.

### TECHNICAL FIELD

An embodiment of the present invention generally relates to a method for detecting sensors, and in particular to a method for detecting the measurement accuracies of the angle sensors used for measuring the rotation angle of guide vanes and the pressure sensor used for measuring the thrust of the push rod in a gas turbine.

### BACKGROUND ART

In order for a compressor to adapt to different operation statuses of a gas turbine, guide vanes need to be set in the compressor. The flowage of air in the compressor is changed by changing the angle of attack of the guide vanes.

FIG. 1 shows the structure of the guide vane driving mechanism in a prior art gas turbine, where only a part of the guide vanes (80) are depicted for an example purpose. As shown in FIG. 1, the guide vane driving mechanism comprises a driving ring (81), a push rod (82), a plurality of connecting rods (83) corresponding to guide vanes (80), and a plurality of adjusting rods (84) corresponding to guide vanes (80). The push rod (82) is connected to the driving ring (81) and the push rod (82) can push the driving ring (81) to rotate relative to a cylinder (85).

One end of a connecting rod (83) is connected to a guide vane (80) and the other end is connected to one end of an adjusting rod (84). The other end of an adjusting rod (84) is connected to the driving ring (81). When the driving ring (81) rotates relative to the cylinder (85), it drives the adjusting rods (84) and the connecting rods (83) to move so that the guide vanes (80) rotate to change their rotation angles. In addition, the guide vane driving mechanism is equipped with a plurality of elastic bases (86) and the driving ring (81) is connected to the cylinder (85) through these elastic bases (86).

When the push rod (82) exerts a thrust on the driving ring (81), on the one hand, the driving ring (81) will rotate relative to the cylinder (85), and on the other hand, the center of the circle of the driving ring (81) deviates from the center of the circular cross section of the cylinder (85). For the guide vanes (80) which are driven by the driving ring (81) to rotate, the rotation angle of the guide vanes (80) corresponding to the connection between the push rod (82) and the driving ring (81) on the driving ring (81) is maximum, and the rotation angle of the guide vanes (80) far away from the connection between the push rod (82) and the driving ring (81) on the driving ring (81) is minimum.

To measure the thrust of the push rod, it is necessary to install a pressure sensor (88). Two angle sensors (87) (only one is given for an example purpose in FIG. 1) are provided for the gas turbine and are each connected to one guide vane to measure the rotation angles of the connected guide vanes in real time. The mean rotation angle and the difference between the maximum rotation angle and the minimum rotation angle, namely, the maximum rotation angle offset, of all guide vanes are calculated from the rotation angles measured by the two angle sensors.

To keep the calculated vales of the mean rotation angle and the maximum rotation angle offset close to the actual values, the included angle between the connection line from the installation position of one angle sensor to the center of the circular cross section of the cylinder and the connection line from the connection point between the push rod and the driving ring to the center of the circular cross section of the cylinder should be 0°, and the included angle between the connection line from the installation position of the other angle sensor to the center of the circular cross section of the cylinder and the connection line from the connection point between the push rod and the driving ring to the center of the circular cross section of the cylinder should be 180°.

That is to say, one angle sensor can measure the maximum rotation angle of the guide vanes, and the other angle sensor can measure the minimum rotation angle of the guide vanes. The difference between the guide vane rotation angles measured by the angle sensors in these two positions is the maximum rotation angle offset, and the mean guide vane rotation angle measured in these two positions is the mean rotation angle of all guide vanes.

A zero shift will happen to the angle sensors and the pressure sensor during use and thus their measurement accuracies will be affected.

### SUMMARY

An embodiment provides a method for detecting sensors in a gas turbine so as to detect the measurement accuracies of the angle sensors and the pressure sensor.

An embodiment of the present invention is directed to a method for detecting sensors in a gas turbine, wherein the gas turbine comprises a cylinder, a plurality of guide vanes, a first angle sensor with an installation angle of 0°, a second angle sensor with an installation angle of 180°, and a guide vane driving mechanism which can drive the guide vanes to rotate. The guide vane driving mechanism comprises a driving ring, a push rod which can push the driving ring to rotate relative to the cylinder, a plurality of connecting rods and adjusting rods connecting the guide vanes and the driving ring, and a plurality of elastic support bases connecting the cylinder and the driving ring.

The method for detecting angle sensors includes: measuring the thrust of the push rod; measuring the first rotation angle of the guide vanes in the installation position of the first angle sensor; measuring the second rotation angle of the guide vanes in the installation position of the second angle sensor; obtaining a measured maximum rotation angle offset according to the absolute value of the difference between the first rotation angle and the second rotation angle; obtaining a calculated maximum rotation angle offset according to the thrust of the push rod, that is, maxΔα=F×K, where F is the thrust of the push rod and K is a geometric constant related to geometric parameters of the guide vane driving mechanism; calculating the absolute value of the difference between the measured maximum rotation angle offset and the calculated maximum rotation angle offset, if the absolute value is less than or equal to a standard value, determining that the angle sensors and the pressure sensor have a suitable sensing accuracy, and if the absolute value is greater than the standard value, determining that the angle sensors and/or the pressure sensor need/needs to be calibrated.

In another example embodiment of the method for detecting sensors in a gas turbine, the calculation formula of the geometric constant is

$$K = \frac{{R}_{a} + {R}_{t}}{{R}_{a} \times l \times {K}_{G}} ,$$

where l is the length of the connecting rod of a guide vane, Rₜ is the distance from the connection between an adjusting rod and the driving ring to the center of the circular cross section of the cylinder, Rₐ is the distance from the connection between the pushing rod and the driving ring to the center of the circular cross section of the cylinder, and K_{G} is the overall elasticity coefficient of the elastic support bases.

In a third example embodiment of the method for detecting sensors in a gas turbine, the standard value is 0.5°.

### BRIEF DESCRIPTION OF THE DRAWINGS

The following drawings are used to give an example description and explanation of the present invention, but do not limit the scope of the present invention.

FIG. 1 shows the structure of a prior art compressor.

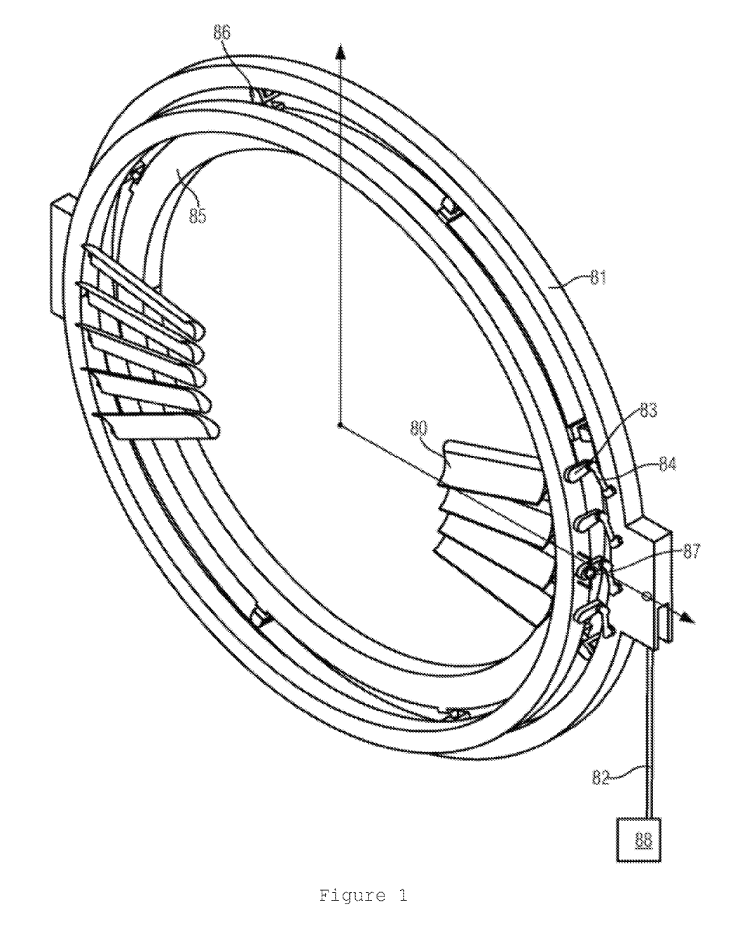

FIG. 2 shows the exploded structure of the guide vane driving mechanism in a gas turbine.

FIG. 3 shows the structure of the guide vane driving mechanism in FIG. 2 after assembly.

FIG. 4 shows the enlarged structure of Part IV in FIG. 2.

FIG. 5 is used to describe the overall elasticity coefficient of the elastic support bases.

FIG. 6 is used to describe the flowchart of the method for detecting sensors in a gas turbine.

### DETAILED DESCRIPTION OF THE INVENTION

To help to understand the technical characteristics, objective, and effect of the present invention more clearly, the following describes an embodiment of the present invention with reference to the drawings in which the same reference number represents the same component.

In this document, “example” means “acting as an instance, example, or illustration”, and any illustration or embodiment described in this document should not be interpreted as a more preferred or advantageous technical solution.

For the simplicity of the drawings, only the parts related to the present invention are shown for an example purpose and they do not represent the actual structure of a product. In addition, only one of the components which have the same structure or function is depicted or marked for an example purpose in some drawings so that the drawings are simplified to help you to understand.

In this document, “one” not only represents “only one”, but also may represent “more than one”. In this document, “first” and “second” are used only to distinguish components from each other, but do not represent their importance or sequence. In this document, the value of an angle is not a limitation in a strict mathematic and/or geometric sense, but also includes an error which those skilled in the art can understand and is allowable for a measurement or a calculation.

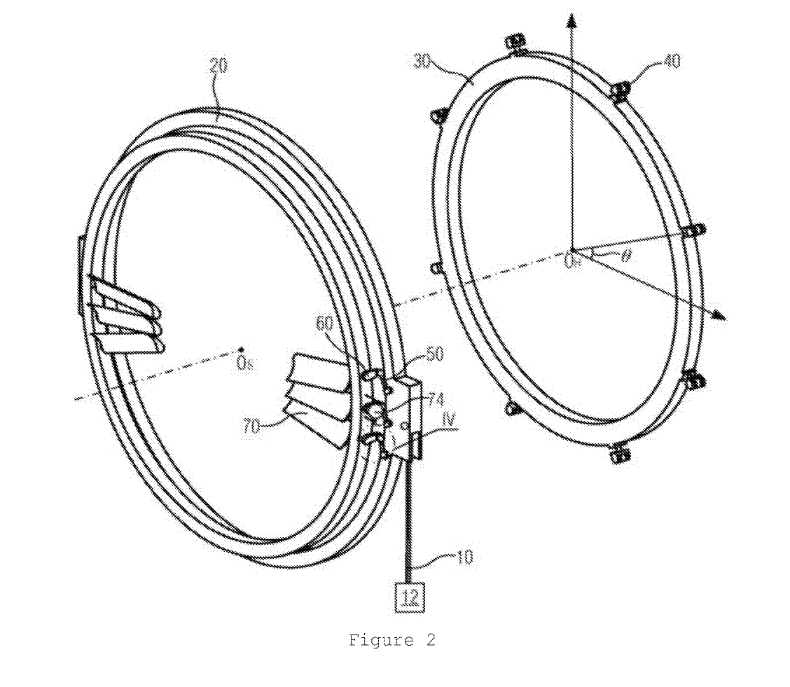

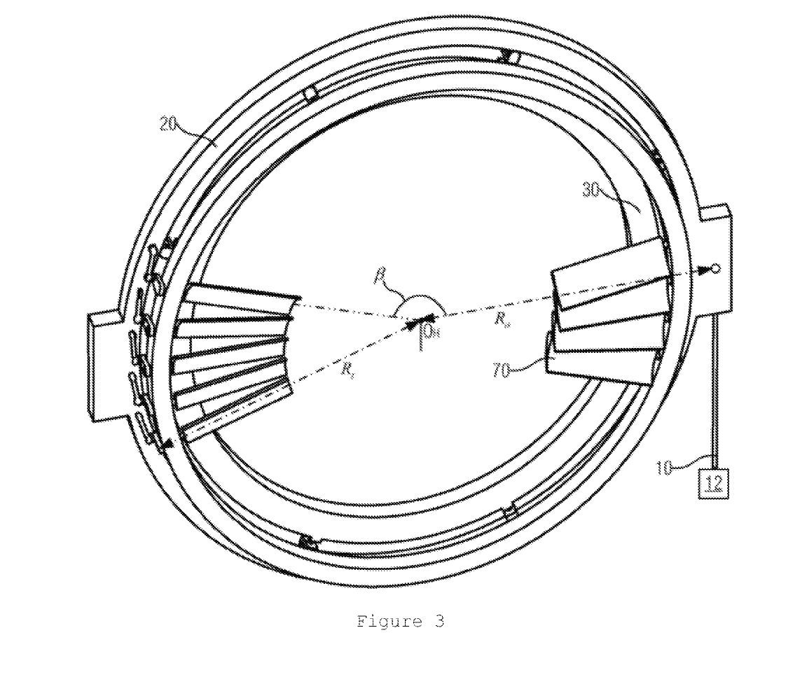

FIG. 2 shows the exploded structure of the guide vane driving mechanism in a gas turbine. FIG. 3 shows the structure of the guide vane driving mechanism in FIG. 2 after assembly. To clearly show the structure of the guide vane driving mechanism, FIG. 2 and FIG. 3 depict only a part of the guide vanes for an example purpose. See FIG. 2 and FIG. 3. The guide vane driving mechanism comprises a push rod (10), a driving ring (20), a cylinder (30), and eight elastic support bases (40), six adjusting rods (50), and six connecting rods (60).

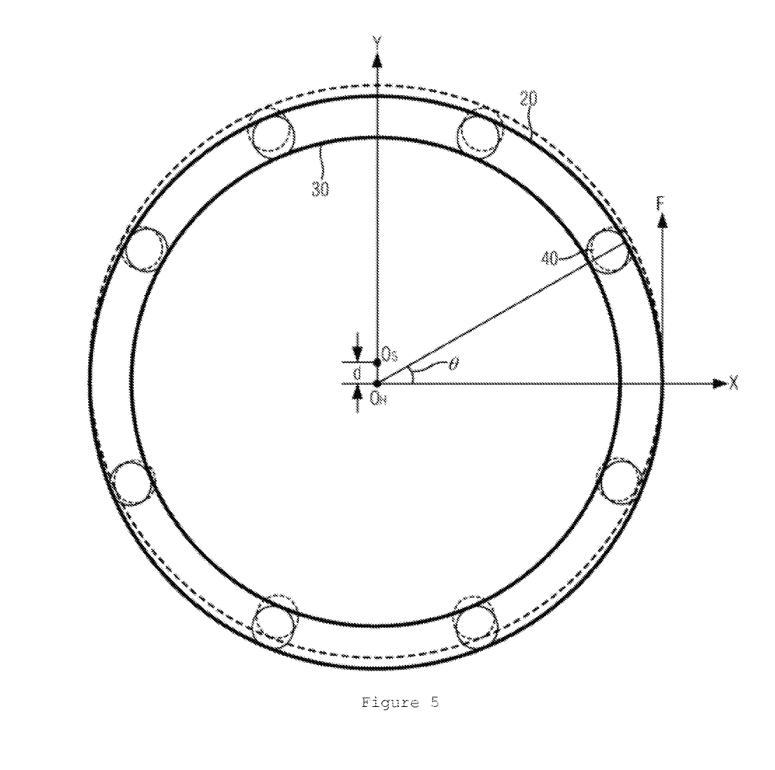

The pushing rod (10) is connected to the driving ring (20). The thrust (F) exerted by the push rod (10) can push the driving ring (20) to rotate relative to the cylinder (30). The driving ring (20) has a center of circle ◯ₛ and the cylinder (30) has a center of circular cross section ◯_{H}, namely, a center of the circular cross section vertical to the central axis of the cylinder (30) around the cylinder (30). When the push rod does not exert a thrust (F) on the driving ring (20), the center of circle ◯ₛ overlaps the center of circle ◯_{H}; when the push rod exerts a thrust (F) on the driving ring (20), the center of circle ◯ₛ deviates from the center of the circular cross section ◯_{H} (see FIG. 5).

Eight elastic support bases (40) are set between the cylinder (30) and the driving ring (20). The elastic support bases (40) can provide elastic support for the driving ring (20). The elastic support provided by the elastic support bases (40) can reduce the stress level caused by thermal expansion of the cylinder (30), and when the center of circle ◯ₛ deviates from the center of the circular cross section ◯_{H}, the elastic support bases (40) can always touch against the driving ring (20). Each elastic support base (40) has a distribution angle θ and the distribution angle is an included angle between the connection line from the elastic support base (40) to the center of the circular cross section ◯_{H} and the horizontal line passing through the center of the circular cross section ◯_{H}.

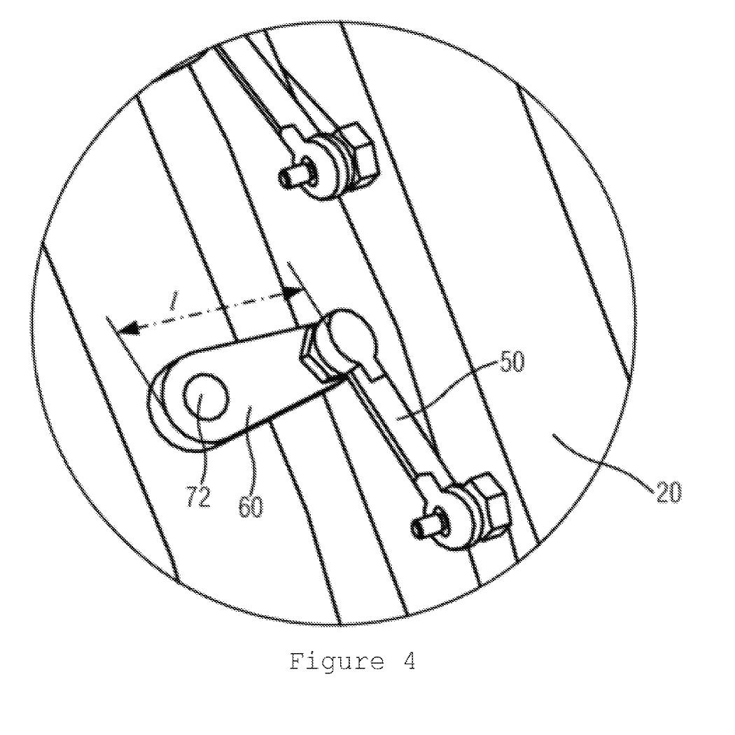

FIG. 4 shows the enlarged structure of Part IV in FIG. 2. As shown in FIG. 2, FIG. 3, and FIG. 4, one end of an adjusting rod (50) is connected to the driving ring (20), and the other end of the adjusting rod (50) is connected to one end of a connecting rod (60). The other end, which is not connected to the adjusting rod (50), of the connecting rod (60) is connected to the journal (72) of a guide vane (70). When the driving ring (20) rotates relative to the cylinder (30), through the adjusting rods (50) and the connecting rods (60), the driving ring (20) drives guide vanes (70) to rotate to change their rotation angles a. The length of a connection rod (60) is l. The distance from the connection between the push rod (10) and the driving ring (20) to the center of the circular cross section ◯_{H} is Rₐ. The distance from the connection between an adjusting rod (50) and the driving ring (20) to the center of the circular cross section ◯_{H} is Rₜ.

To distinguish between the two angle sensors (74) (only one is shown in FIG. 2), the two angle sensors are named the first angle sensor and the second angle sensor, respectively. The two angle sensors are respectively connected to the journal of a guide vane. The included angle between the connection line from the guide vane in the installation position of an angle sensor to the center of the circular cross section ◯_{H} and the connection line from the connection between the push rod (10) and the driving ring (20) to the center of the circular cross section ◯_{H} is called installation angle for short below. For the first angle sensor, the installation angle is 0° and the measured rotation angle of a guide vane is the first rotation angle α₁; for the second angle sensor, the installation angle is 180° and the measured rotation angle of a guide vane is the second rotation angle α₂.

Through the first rotation angle α₁ and the second rotation angle α₂, the mean rotation angle αₘₑₐₙ of all the guide vanes, and the difference between the maximum rotation angle and the minimum rotation angle among all the guide vanes, namely, the maximum rotation angle offset maxΔα, can be reflected. The first rotation angle α₁ is the maximum rotation angle of all the guide vanes and the second rotation angle α₂ is the minimum rotation angle of all the guide vanes. In this case, the maximum rotation angle offset is the difference between the first rotation angle α₁ and the second rotation angle α₂, and the mean rotation angle is the mean value of the first rotation angle α₁ and the second rotation angle α₂. The thrust (F) of the push rod is measured by the sensor (12) set on the push rod.

FIG. 5 is used to describe the overall elasticity coefficient of the elastic support bases and the imaginary circle represents the displaced driving ring. See FIG. 5. The elastic support bases (40) set between the cylinder (30) and the driving ring (20) can respectively provide elastic support for the driving ring (20). The included angle between the direction of the elastic force exerted by an elastic support base (40) on the driving ring (20) and the horizontal line (in the X direction in FIG. 4) passing through the center of the circular cross section ◯_{H} is the distribution angle θ of the elastic support base (40) and the elasticity coefficient of each elastic support base (40) is Kₛ. When the push rod (10) exerts a thrust (F) on the driving ring (20), the elastic force exerted by each elastic support base (40) on the driving ring (20) can balance the thrust (F), that is to say, the resultant force of the component forces of all the elastic support bases (40) in the Y direction in FIG. 4 is equal to the thrust (F). The sum of the components of the elasticity coefficient Kₛ of all the elastic support bases (40) in the Y direction is defined as K_{G}, namely, the overall elasticity coefficient of elastic support bases 40, and

$${K}_{G} = {K}_{s} {\sum }_{l}^{K} {sin}^{2} ( {θ}_{i} ) ,$$

where i represents a different elastic support base. Hence, the thrust (F) exerted by the push rod (10) is equal to K_{G}d, where d is the displacement of the driving ring (20) in the Y-axis direction.

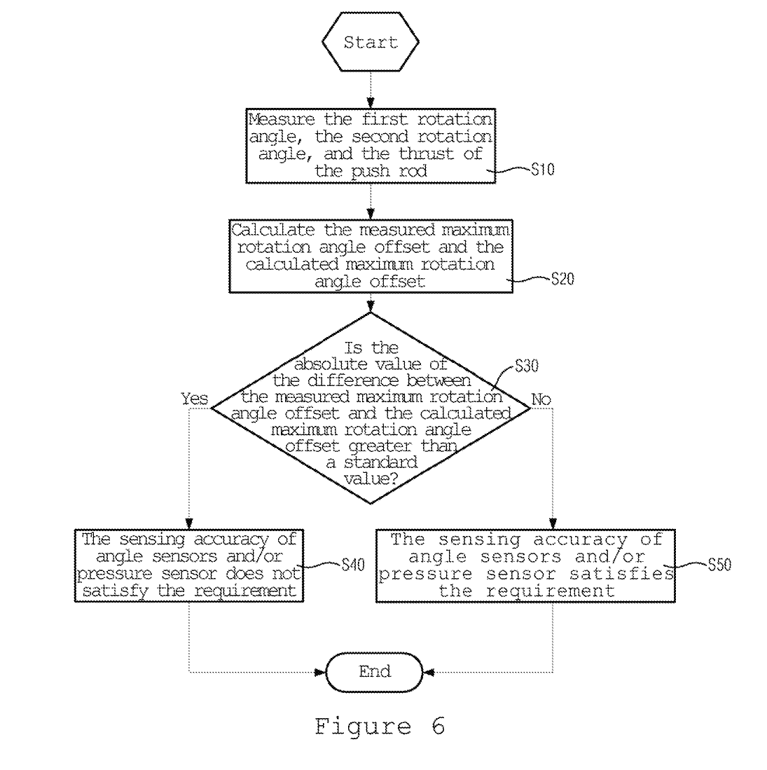

FIG. 6 is used to describe the flowchart of the method for detecting sensors in a gas turbine. As shown in FIG. 6, the method for detecting sensors in a gas turbine starts from Step S10. In Step S10, obtain two different guide vane rotation angles from the measurements of the first angle sensor and the second angle sensor. Obtain the first rotation angle α₁ from the measurement of the first angle sensor and the second rotation angle α₁ from the measurement of the second angle sensor. Obtain the thrust (F) of the push rod from the measurement. After completing the measurements of the first rotation angle α₁, the second rotation angle α₂, and the thrust (F) of the push rod in Step S10, go to Step S20.

In Step S20, obtain the measured maximum rotation angle offset according to the difference between the first rotation angle α1 and the second rotation angle α₂, namely, α₁−α₂. Obtain the calculated maximum rotation angle offset maxΔα according to the thrust F measured by the pressure sensor and the calculation formula maxΔα=F×K, where K2 is a constant related to the guide vane driving mechanism.

In an example embodiment of the method for detecting sensors in a gas turbine, the calculation formula of K is:

$$K = \frac{{R}_{a} + {R}_{t}}{{R}_{a} \times l \times {K}_{G}} ,$$

where L is the length of a connecting rod, Rₜ is the distance from the connection between an adjusting rod and a connecting rod to the center of the circular cross section ◯_{H}, Rₐ is the distance from the connection between the push rod and the driving ring to the center of the circular cross section, and K_{G} is the overall elasticity coefficient of the elastic support bases.

In Step S30, compare the measured maximum rotation angle offset α₁−α₂ with the calculated maximum rotation angle offset maxΔα, if the absolute value of the difference between the measured maximum rotation angle offset α₁−α₂ and the calculated maximum rotation angle offset maxΔα is greater than a standard value, go to Step S40; if the absolute value of the difference between the measured maximum rotation angle offset α₁−α₂ and the calculated maximum rotation angle offset maxΔα is less than or equal to a standard value, go to Step S50. In an example embodiment of the measurement method of the guide vane driving mechanism, the standard value is 0.5°.

In Step S40, determine that the sensing accuracy of the angle sensors and/or pressure sensor does not satisfy the requirement, further determine the conditions of the angle sensors and the pressure sensor, and calibrate the sensor(s) which has (have) a problem to complete the method for detecting sensors in the gas turbine.

In Step S50, determine that the sensing accuracy of the angle sensors and pressure sensor satisfies the requirement and complete the method for detecting sensors in the gas turbine.

It should be understood that although the Description gives a description by embodiment, it does not mean that each embodiment contains only one independent technical solution. The description method in the Description is only for the sake of clarity. Those skilled in the art should consider the Description as an integral body. The technical solutions in these embodiments can be combined properly to form other embodiments that those skilled in the art can understand.

The series of detailed descriptions above are only specific descriptions of feasible embodiments of the present invention and they are not intended to restrict the protection scope of the present invention. All equivalent embodiments or variants, for example, combination, division, or duplication of technical characteristics, without departure from the spirit of the present invention should fall within the protection scope of the present invention.

### DESCRIPTION OF REFERENCE NUMBERS IN THE DRAWINGS

10: Push rod
12: Pressure sensor
20: Driving ring
30: Cylinder
40: Elastic support base
50: Adjusting rod
60: Connecting rod
70: Guide vane
72: Journal
74: Angle sensor
80: Guide vane
81: Driving ring
82: Push rod
83: Connecting rod
84: Adjusting rod
85: Cylinder
86: Elastic base
87: Angle sensor
88: Pressure sensor

1. A method for sensors in a gas turbine, the gas turbine including a cylinder, a plurality of guide vanes, a first angle sensor, a second angle sensor, and a guide vane driving mechanism configured to drive the guide vanes to rotate, the guide vane driving mechanism including a driving ring, a push rod configured to push the driving ring to rotate relative to the cylinder, a pressure sensor configured to measure a thrust of the push rod, a plurality of connecting rods and adjusting rods connecting the guide vanes and the driving ring, and a plurality of elastic support bases connecting the cylinder and the driving ring, the method comprising:
measuring thrust of the push rod via the pressure sensor;
measuring a first rotation angle of the guide vanes in an installation position of the first angle sensor;
measuring a second rotation angle of the guide vanes in an installation position of the second angle sensor;
obtaining a measured maximum rotation angle offset according to an absolute value of a difference between said measured first rotation angle and said measured second rotation angle;
calculating maximum rotation angle offset maxΔα according to maxΔα=F×K, where F is the thrust and K is a constant related to the guide vane driving mechanism; and
calculating an absolute value of a difference between the obtained measured maximum rotation angle offset and said calculated maximum rotation angle offset maxΔα and, upon the absolute value being relatively less than or equal to a standard value, determining that the angle sensors and the pressure sensor have a suitable sensing accuracy and, upon the absolute value being relatively greater than the standard value, determining that calibration is desired for at least one of
at least one of the angle sensors and
the pressure sensor.

2. The method for sensors in a gas turbine of claim 1, wherein the constant (K) is calculated by:
where l is a length of the connecting rod of the guide vane,
Rt is a distance from the connection between the adjusting rod and the driving ring to a center of a circular cross section of the cylinder,
Ra is a distance from the connection between the push rod and the driving ring to the center of the circular cross section of the cylinder, and KG is an overall elasticity coefficient of the elastic support bases.

3. The method for sensors in a gas turbine of claim 1, wherein the standard value is 0.5°.

4. The method for sensors in a gas turbine of claim 2, wherein the standard value is 0.5°.

5. The method for sensors in a gas turbine of claim 1, further comprising:
determining, upon determining that calibration is desired for at least one of at least one of the angle sensors and the pressure sensor, conditions of at least one of the angle sensors and the pressure sensor, and
calibrating the at least one of the at least one of the angle sensors and the pressure sensor for which the determination indicates that calibration is desired.

6. The method for sensors in a gas turbine of claim 2, further comprising:
determining, upon determining that calibration is desired for at least one of at least one of the angle sensors and the pressure sensor, conditions of at least one of the angle sensors and the pressure sensor, and
calibrating the at least one of the at least one of the angle sensors and the pressure sensor for which the determination indicates that calibration is desired.

7. The method for sensors in a gas turbine of claim 3, further comprising:
determining, upon determining that calibration is desired for at least one of at least one of the angle sensors and the pressure sensor, conditions of at least one of the angle sensors and the pressure sensor, and
calibrating the at least one of the at least one of the angle sensors and the pressure sensor for which the determination indicates that calibration is desired.

8. The method for sensors in a gas turbine of claim 4, further comprising:
determining, upon determining that calibration is desired for at least one of at least one of the angle sensors and the pressure sensor, conditions of at least one of the angle sensors and the pressure sensor, and
calibrating the at least one of the at least one of the angle sensors and the pressure sensor for which the determination indicates that calibration is desired.

9. The method for sensors in a gas turbine of claim 1, wherein the first angle sensor has an installation angle of 0° and the second angle sensor has an installation angle of 180.
